(19) United States
(12) Patent Application Publication
(10) Pub. No.: US 2005/0166177 A1
(43) Pub. Date: Jul. 28, 2005

(54) Thread module chaining

(76) Inventors: Ylian Saint-Hilaire, Hillsboro, OR (US); Bryan Y. Roe, Camas, WA (US); Nelson F. Kidd, Camas, WA (US)

Correspondence Address: SCHWABE, WILLIAMSON & WYATT, P.C.;PACWEST CENTER, SUITE 1900, 1211 SW FIFTH AVENUE, PORTLAND, OR, 97204, US

(21) Appl. No.: 10/766,545

(22) Filed: Jan. 27, 2004

(51) Int. Cl. G06F 9/44

(52) U.S. Cl. 717/100

(57) ABSTRACT

One or more modules are designed to enable themselves to be logically chained to one or more other modules dynamically, for execution as part of the same thread as the other modules. In various embodiments, a thread module chaining service is provided to facilitate the dynamic chaining and chained execution of the modules.

### TECHNICAL FIELD

The present invention relates to the field of data processing, including, but not limited to, application design and execution.

### BACKGROUND

Advances in microprocessor and related technologies have led to wide spread deployment and adoption of computing devices. Their form factors vary from desktop, laptop, palm sized, and so forth. A number of these computing devices are packaged as “special purpose” devices, such set-top boxes, entertainment control centers, personal digital assistants (PDA), pagers, text messengers, wireless mobile phones, and so forth.

While many of these devices have computing powers that used to be available only in very expensive main frame computers requiring conditioned operating environment, execution resources remain “insufficient”, as demands for execution resources continue to outstrip supplies, due to the ever increasing richness and complexity of the applications being deployed on these computing devices.

### BRIEF DESCRIPTION OF THE DRAWINGS

The present invention will be described by way of exemplary embodiments, but not limitations, illustrated in the accompanying drawings in which like references denote similar elements, and in which:

FIG. 1 illustrates an overview of the one embodiment of the present invention;

FIGS. 2a-2b illustrate an outline view of an example module_0 and an example module_i of FIG. 1 respectively, in accordance with one embodiment;

FIG. 3 illustrates the thread control data structure of FIG. 1 in further detail, in accordance with one embodiment;

FIGS. 4a-4b illustrate parts of the operational flow of the thread module chaining service of FIG. 1, in accordance with one embodiment;

FIG. 5 illustrates an architectural view of an example computing device incorporated with the modules and thread module chaining service of FIG. 1, in accordance with one embodiment;

FIG. 6 illustrates a block diagram view of a machine readable article incorporated with the modules and/or thread module chaining service of FIG. 1, in accordance with one embodiment;

FIG. 7 illustrates a system view of an example system with at least one of the device incorporated with the modules and thread module chaining service of FIG. 1, in accordance with one embodiment; and

FIGS. 8a-8b illustrate an overview of the protocol for the UPnP control point, media servers and media renderers of the example system of FIG. 7 for interacting with one another, in accordance with one embodiment.

### DETAILED DESCRIPTION OF ILLUSTRATIVE EMBODIMENTS

Embodiments of the present invention include, but are not limited to, modules designed to be chained to other modules for execution as part of the same thread of the other modules, modules causing the chaining, services facilitating the chaining, computing devices, medium and/or systems incorporated with the modules to be chained, modules causing the chaining, and/or services facilitating the chaining.

Various aspects of the illustrative embodiments will be described using terms commonly employed by those skilled in the art to convey the substance of their work to others skilled in the art. However, it will be apparent to those skilled in the art that the present invention may be practiced with only some of the described aspects. For purposes of explanation, specific numbers, materials and configurations are set forth in order to provide a thorough understanding of the illustrative embodiments. However, it will be apparent to one skilled in the art that the present invention may be practiced without the specific details. In other instances, well-known features are omitted or simplified in order not to obscure the illustrative embodiments.

Various operations will be described as multiple discrete operations, in turn, in a manner that is most helpful in understanding the present invention, however, the order of description should not be construed as to imply that these operations are necessarily order dependent. In particular, these operations need not be performed in the order of presentation.

The phrase “in one embodiment” is used repeatedly. The phrase generally does not refer to the same embodiment, however, it may. The terms “comprising”, “having” and “including” are synonymous, unless the context dictates otherwise.

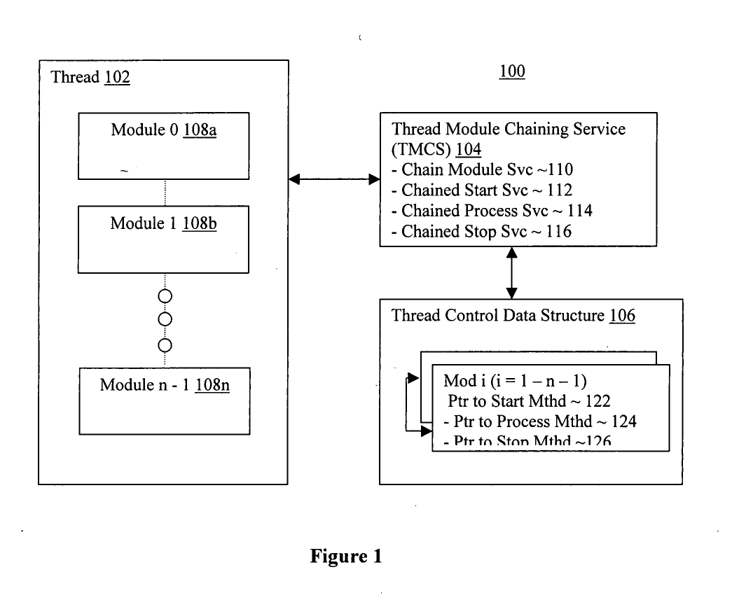

Referring now to FIG. 1, wherein an overview of an embodiment of present invention is illustrated. As shown, thread 102 executing in computing environment 100 is advantageously formed dynamically, by logically chaining together its constituting modules, module_0 through module_n 108a-108n. The term “thread” as used herein, unless the context of usage indicates otherwise, refers to a sequence of instructions being executed with one execution management context, as the term is commonly understood by those skilled in the art. As will be readily apparent from the description to follow, by virtue of the manner module_0 through module_n 108a-108n are designed to make possible the modules to be logically chained together dynamically, and executed as parts of the same thread 102, functionally, each module 108a-108n may be designed substantially independent of each other. Yet, by virtue of the modules being executed together in a single thread, the amount of resources required to manage their executions are smaller that the amount of resources required to execute the modules as different threads, due to the fact that different thread contexts are no longer required to manage their executions.

Further, module_0 108a may be easily modified to chain other modules of like design to form other threads for other applications. Similarly, each of module_1 through module_n 108b-108n, if desired, may be chained to one or more other module chains forming other threads. These other module chains may be executed in the same or other computing environments. Resultantly, modules 108a-108n may be highly re-useable, and development productivity may be improved.

Continuing to refer to FIG. 1, for the embodiment, thread module chaining service 104 is provided to facilitate the above described dynamic and logical chaining of modules to form thread 102, and execution of modules 108a-108n as parts of the same thread 102. Thread module chaining service 104 may include chain module service 110, chained start service 112, chained process service 114, and chained stop service 116, to be described more fully below.

Further, thread module chaining service 104 may employ thread control data structure 106 to provide services 110-116 to facilitate the dynamic logical chaining of modules 108a-108n, and their chain executions. Thread control data structure 106 may include in particular, access information for each module (e.g. pointers) 122-126 for accessing chained start instructions, chained process instructions, and chained stop instructions of the various modules (organized e.g. in the form of methods), also to be described more fully below. The term “method” as used herein, unless the context of the usage indicates otherwise, refers to a set of executable instructions organized in accordance with the principles in the field of object-oriented programming, as the term is commonly understood by those skilled in the art.

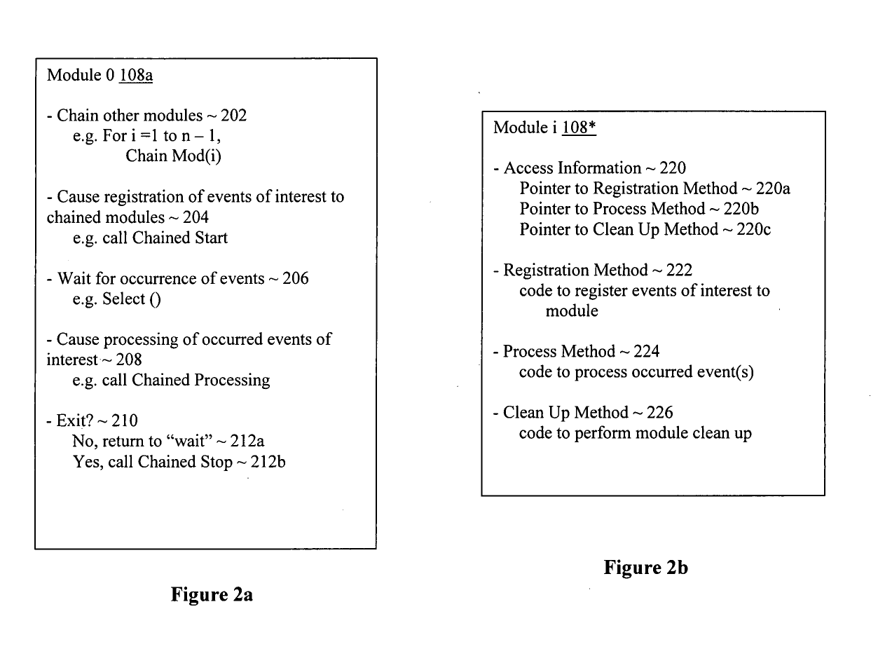

FIGS. 2a-2b illustrate an outline view of an example chaining module (module_0) and an example of a chained module (module_i) of FIG. 1 respectively, in accordance with one embodiment. As illustrated in FIG. 2b, example module_i 108* is designed/architected to facilitate ease of dynamically chaining the module to other modules, to enable the module to be executed as part of the same thread as the other modules. Example module_108* may include a method 222 to register the events of interests to the module with an event notification service (not shown) of a computing environment, a method 224 to process an occurred event of interest, and a method 226 to perform module clean up during thread termination. The exact content of each of these methods are application dependent. However, one skill in the art would recognize that the architecture is particularly useful for modules that are input/output (I/O) oriented. Further, example module_i 108* may include access information 220 to facilitate chained invocation of the methods 222-226. Access information 220 may include a number of pointers, a pointer 220a to registration method 222, a pointer 220b to process method 224 and a pointer 220c to module clean up method 226.

Yet further, access information 220 may be formed and/or organized in a manner that allow access information 220 to be ascertained, retrieved, determined, or extracted by a chaining entity (which may be a chaining module or a service servicing a chaining module). In one embodiment, access information 220, such as pointers 220a-220c may be located at a predetermined location, such as the beginning of example module_i 108*.

As illustrated in FIG. 2a, example module 0 108a may include complementary logic for chaining the modules, and for chain executing the chained modules. In particular, example module 0 108a may include instructions 202 to chain the additional modules to be executed together (as part of the same thread), as desired. In various embodiments, instructions 202 may comprise invoking the Chain Module service 110 of a thread module chaining service 104.

Example module 0 108a further may include instructions 204 to cause the chained modules to register events of interest to the chained modules. In various embodiments, instructions 204 may comprise invocation of Chain Start service 112 of a thread module chaining service 104 to cause the respective registration methods to be chain executed.

Additionally, example module 0 108a may include instructions 206 to wait for the occurrence of one or more of the events of interest. In various embodiments, instructions 206 may e.g. include a Select( ) like function.

Example module 0 108a may further include instructions 208 to cause the chained modules to process occurred ones of the registered events of interest. In various embodiments, instructions 208 may comprise invocation of the Chain Process service 114 of a thread module chaining service 104 to cause the respective processing methods to be chained executed. The invocations may also include notifying the process methods of the chained modules being invoked, of the events which occurrence led to the invocations.

Example module 0 108a may further include instructions 210 to determine whether to cause the thread to be terminated or to return to instructions 206. In various embodiments, instructions 210 may comprise invocation of the Chain Clean Up service 116 of a thread module chaining service 104 to cause the respective module clean up methods to be chained executed.

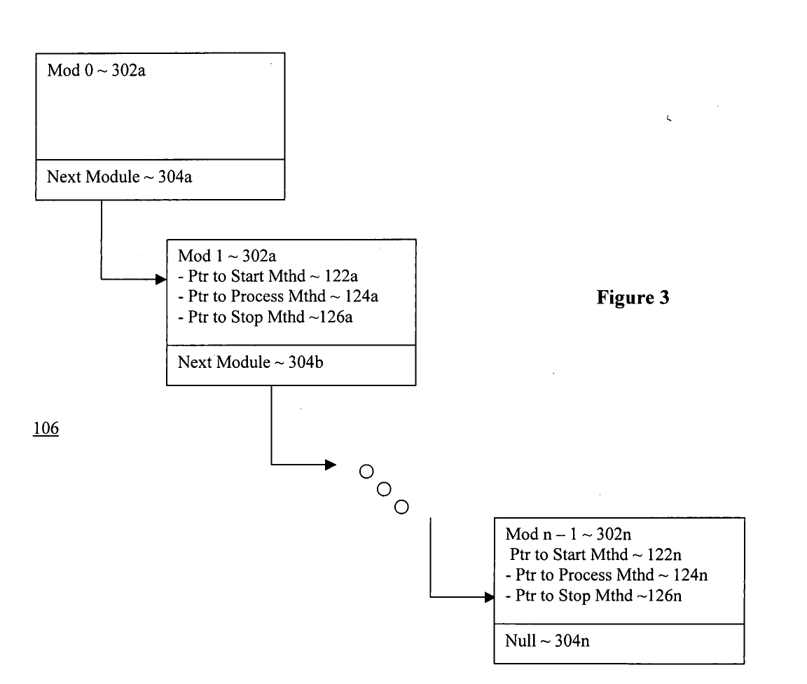

FIG. 3 illustrates the thread control data structure of FIG. 1 in further detail, in accordance with one embodiment. As illustrated and alluded to earlier, thread control data structure 106 comprises control information for each module 302a-302n. For the embodiment, control information for each module 302a-302n are linked together in the form of e.g. a link list. In addition to the access information 122*-126* (*=a, . . . , n) for accessing the Start, Processing and Clean Up instructions of the module, described earlier, for the embodiment, control information for a module 302* (*=a, . . . , n) further includes a pointer 304* (*=a, . . . , n) to the control information of the next chained module, with the last pointer 304n being a null pointer. Of course, pointer 304a may be the last pointer 304n when module 0 108a does not chain any other modules, or before chaining. In alternate embodiments, access information of each module 302* may be organized employing other data organization techniques.

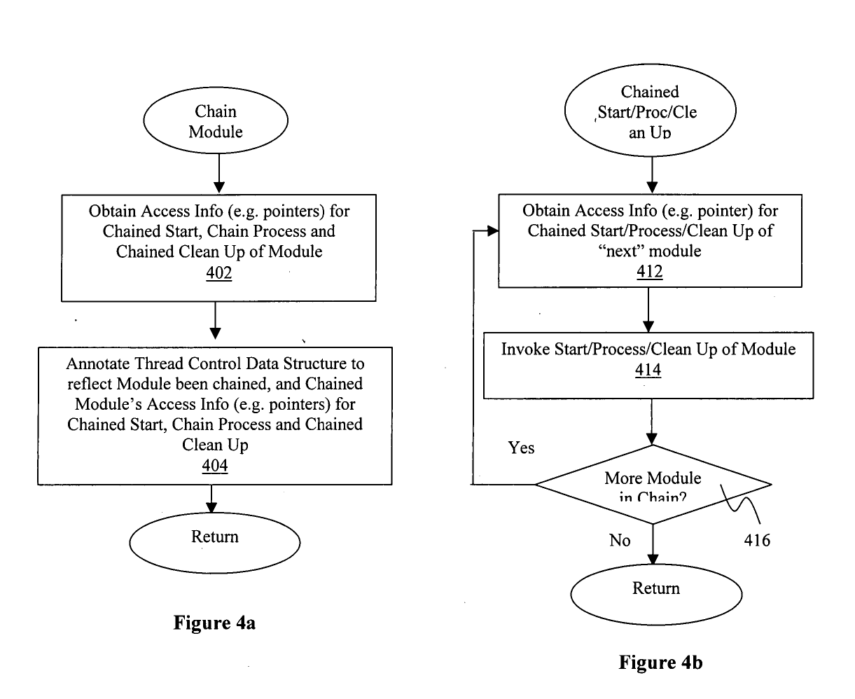

FIGS. 4a-4b illustrate parts of the operational flow of the thread module chaining service of FIG. 1, in accordance with one embodiment. More specifically, FIG. 4a illustrates parts of the operational flow of the Chain Module service and FIG. 4b illustrates parts of a generic operational flow of the Chained Start/Process/Clean-up service.

As illustrated in FIG. 4a, after receipt of a request to chain a module, service 104 dynamically retrieves, ascertains, infers, extracts, or otherwise determines the access information for accessing at least the Start, Process and Clean-up instructions (e.g. in the form of methods) of the module to be chained to the service requesting (chaining) module (and other already chained modules), block 402. As described earlier, in various embodiments, modules to be chained may be designed in a manner to allow service 104 to extract the access information from determined locations within the module.

After dynamically retrieving . . . or otherwise determining the access information of the module to be chained, service 104 updates and annotates the thread control data structure 106 to reflect the fact that the “target” module is chained to the service requesting (chaining) module (and other already chained modules), block 404. For the embodiment, service 104 also updates and annotates the thread control data structure 106 to with the access information for accessing the Start, Process and Clean-up methods of the module being chained, block 404.

Thereafter, the module may be executed as part of the same thread of the chaining module (and other modules already chained to the chaining module).

As illustrated in FIG. 4b, after receipt of a request to chain execute Start, Process and Clean-up of modules 108b-108n of a thread 102, service 104 retrieves the accessing information for accessing the Start, Process or Clean-up methods of the chained modules 108b-108n from thread control data structure 106, depending on whether the request is a request to chain execute Start, Process or Clean-up, block 412. Recall that the Start “methods” of the modules are invoked to register events of interest to the modules respectively, the Process “methods” of the modules are invoked to process one or more occurred events of interest to the “methods” respectively, and Clean-up methods are invoked to perform module clean up at thread termination, respectively After retrieving the accessing information for accessing the Start, Process or Clean-up methods of the chained modules 108b-108n, service 104 successively invokes the Start, Process or Clean-Up “methods” of modules 108b-108n of thread 102 accordingly, to effectuate the chained execution of the Start, Process or Clean-Up “methods” of modules 108b-108n, block 414-416. As described earlier, the invocations of the process methods may also include notifying the process methods being invoked, of the events which occurrence led to the invocations.

Accordingly, modules 108b-108n may be executed as part of the same thread as module 108a, affording the opportunity to reduce the amount of execution resources required to manage their executions.

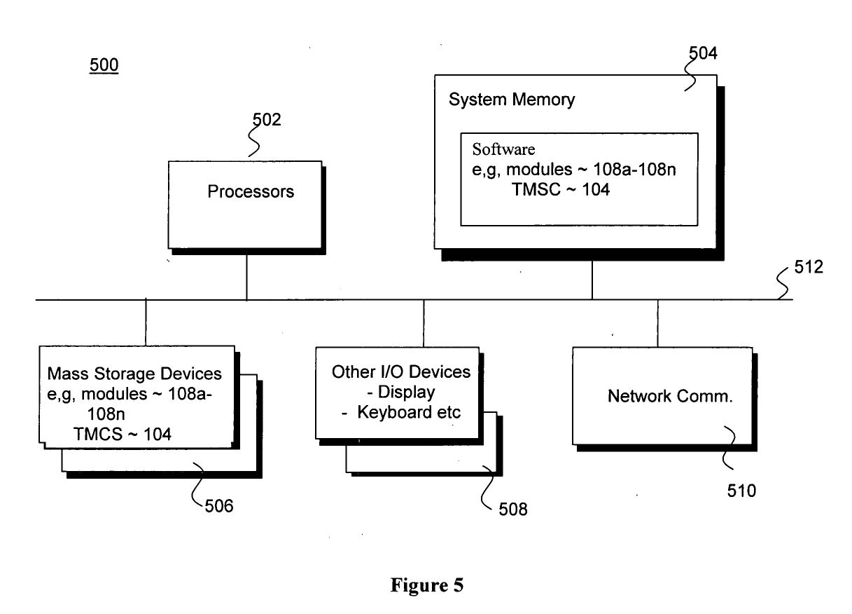

FIG. 5 illustrates an architectural view of an example computing device incorporated with the modules and thread module chaining service of FIG. 1, in accordance with one embodiment. As illustrated, computing device 500 includes one or more processors 502, system memory 504, mass storage devices 506, other I/O devices 508 and network communication interface 510, coupled to each other via system bus 512 as shown.

System memory 504 and mass storage devices 506 may be employed to store various transient and persistent copies of software components, such as modules 108a-108n and thread module chaining services 104. System memory 504 may be Dynamic Random Access Memory (DRAM), Synchronous DRAM (SDRAM) or other memory devices of the like. Mass storage devices 506 may be hard disks, CDROM, DVDROM, and other storage devices of the like.

Processor 502 may be employed to execute various the software components, modules 108a-108n (with chained ones as a single thread) and thread module chaining services 104. Processor 202 may be any one of a number of processors known in the art or to be designed. Examples of suitable processors include but are not limited microprocessors available from Intel Corp of Santa Clara, CA.

Other I/O devices 508 may be employed to facilitate other aspects of input/output. Examples of other I/O devices 508 include but are not limited to keypads, cursor control, video display and so forth.

Network communication interface 510 may be employed to facilitate network communication with other devices. Network communication interface 510 may be wired based or wireless. In various embodiments, network communication interface 510 may also support other networking protocols.

In various embodiments, computing device 500 may be a desktop computer, a laptop computer, a tablet computer, a palm-sized computing device, a PDA, a set-top box, an entertainment center controller, a wireless mobile phone, and so forth.

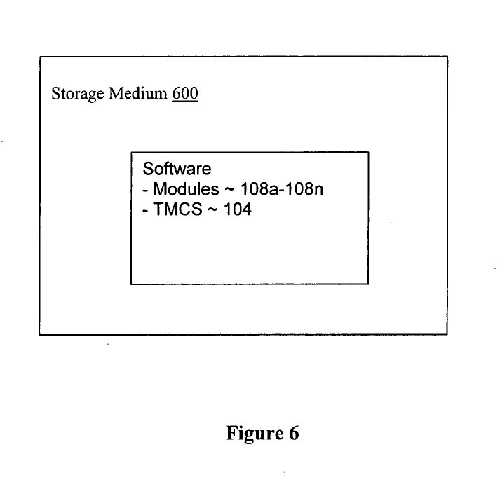

FIG. 6 illustrates a block diagram view of a machine readable article incorporated with the modules and/or thread module chaining service of FIG. 1, in accordance with one embodiment. For the embodiment, the machine readable article includes storage medium 600 and instructions implementing all or portions of modules 108a-108n, and/or thread module chaining service 104, stored therein. The stored instructions may be used to program an apparatus, such as computing device 500 of FIG. 5.

In various embodiments, the instructions may be C or C++ programming language instructions or other system programming language instructions of the like. Further, storage medium 600 may be a diskette, a tape, a compact disk (CD), a digital versatile disk (DVD), a solid state storage devices, or other electrical, magnetic and/or optical storage devices of the like.

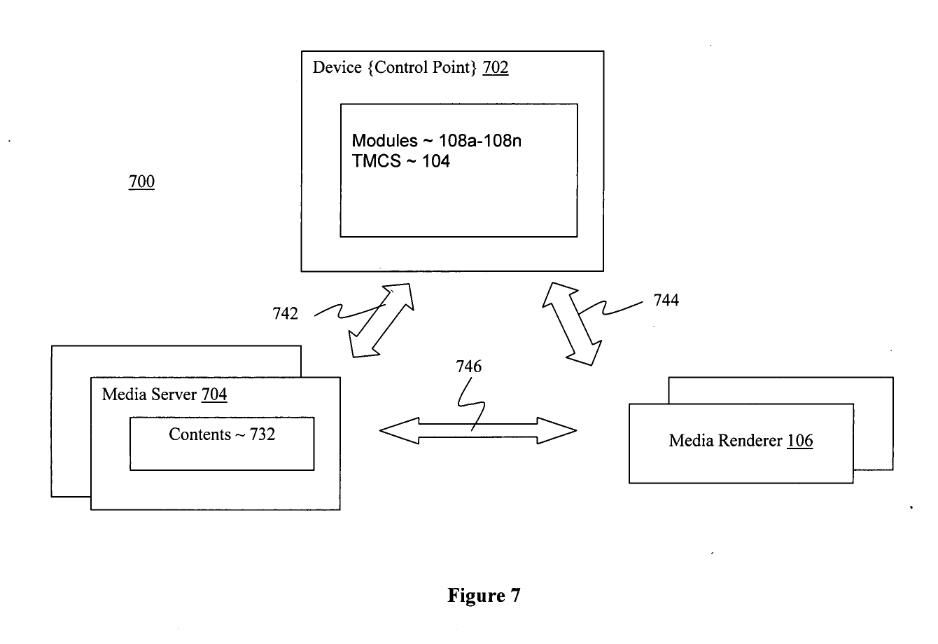

FIG. 7 illustrates a system view of an example system with at least one of the device incorporated with the modules and thread module chaining service of FIG. 1, in accordance with one embodiment. As illustrated, example system 700 may include device 702, operating in the role of a UPnP control point, UPnP media servers 704, and UPnP media renderers 706, operationally coupled to each other as shown. The terms “control point”, “media content”, “media server” and “media renderer” as used herein have the same meaning as the terms are employed in the UPNP A/V Architecture and related specifications, available at the time of filing the present application. In the case of UPnP AN Architecture Specification, that is version 1.0.

UPnP media servers 704 may comprise a number of media contents 732. UPnP media servers 704 provide media contents 732 to selected ones of UPnP media renderers 706 to render, at the control of control point 702. In various embodiments, media contents 732 provided by UPnP media servers 704 may include media contents 732 accessible to UPnP media servers 704, but not disposed on UPnP media servers 704 itself.

Media contents 732 may be audio, video, textual, graphical, pictorial, and/or other contents of the like, including combinations thereof. Each UPNP media renderer 706 may be equipped to render one or more of the enumerated media types, i.e. audio, video, and so forth.

In general, the term “media content” as used herein is synonymous with the term “media item” used in the earlier identified UPnP Specification, unless the context clearly indicates to the contrary.

In various embodiments, elements 702-706 may be coupled to each other wirelessly 742-746, i.e. they are members of a wireless network domain. In other embodiments, elements 702-706 may be coupled to each other as members of a wire based network domain.

Regardless of the manner elements 702-706 are coupled to each other, for the embodiment, elements 702-706 may be equipped to operate in accordance with the above described UPnP family of specifications.

Additionally, for the embodiment, control point device 702 may include various media related services implemented in chainable modular organizations as described earlier, and thread module chaining service 104. The chainable modules 108a-108n and thread module chaining service 104 may be equipped to enable media contents 732 be available from UPnP media servers 704, and availability of UPnP media renderers 706 be made visible through an user interface of control point device 702.

Further, selection of media content 732 for rendering, and media renderer 706 to perform the rendering, may be made through the same user interface. Preferably, the user interface is a graphical user interface.

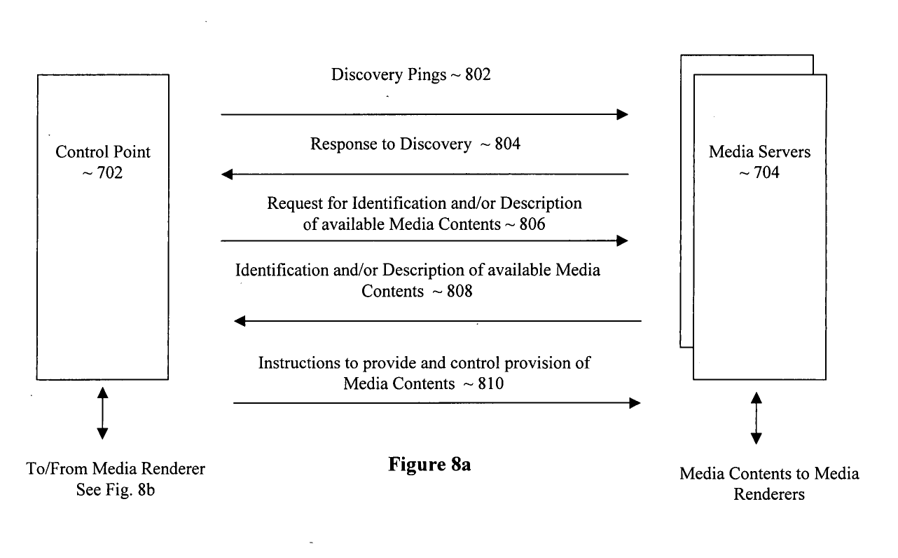

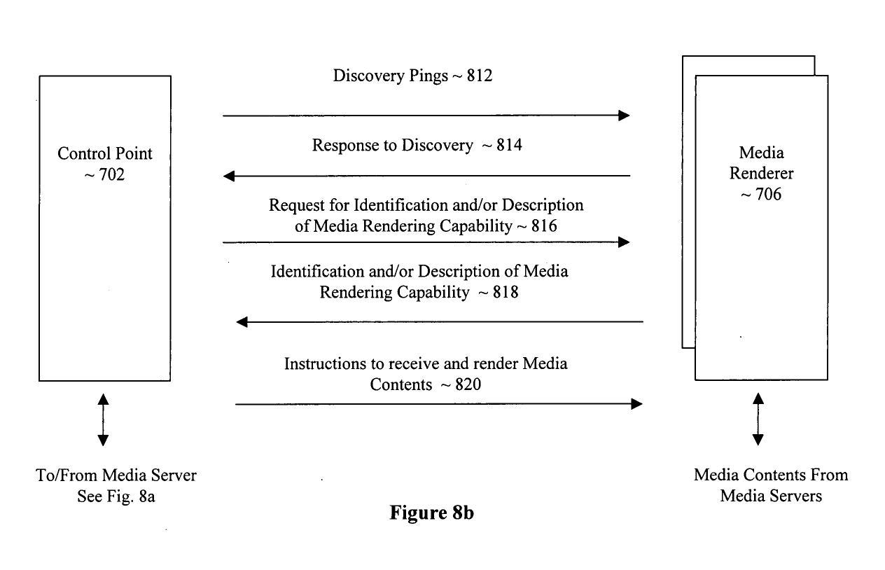

FIGS. 8a-8b illustrate an overview of the protocol and methods for the UPnP control point, media servers and media renderers of FIG. 7 to interact with one another, in accordance with one embodiment. As illustrated in FIG. 8a, control point device 702 first discovers the presence of various UPnP media servers 704 in an operating environment or more specifically, a network domain, by issuing discovery requests in accordance with the earlier mentioned UPnP AN Architecture Specification, op 802.

In response, UPnP media servers 704 respond as called for by the earlier mentioned UPnP A/V Architecture Specification, op 804.

In response to the receipt of each of these responses, control point device 702 requests for the identifications of media contents 732 available from the responding UPnP media server 704, in accordance with the earlier mentioned UPnP A/V Architecture Specification, op 806. For the embodiment, control point device 702 also requests for the corresponding meta data describing the available media contents 732.

In response, the UPnP media server 774 provides the identifications of media contents 732 available, including if applicable, the meta data describing the available media contents 732, op 808.

As alluded to earlier, and to be more fully described below, on receipt of the identifications and meta data, control point device 702 advantageously makes visible these information through the user interface of control point device 702.

Examples of meta data may include, but are not limited to, the title, the size, the version, date of creation, the media type, the artist, and so forth of the media content 732.

In various embodiments, operations 806 and 808 may be performed via one or more sets of requests and responses.

Thereafter, during operation, at an appropriate time, in response to a user selection to render a media content, control point device 702 instructs the applicable UPnP media servers 704 accordingly, to provide applicable ones of media contents 732 to the appropriate ones of UPnP media renderers 706, op 710. In alternate embodiments, control point device 702 may instruct a UPnP media renderer to pull the applicable media content from the applicable UPnP media server 704 instead.

As illustrated in FIG. 8b, control point device 702 first discovers the presence of various UPnP media renderers 706 in an operating environment or more specifically, a network domain, by issuing discovery pings in accordance with the earlier mentioned UPnP A/V Architecture Specification, op 812.

In response, UPnP media renderers 706 respond as called for by the earlier mentioned UPnP A/V Architecture Specification, op 814.

For the embodiment, in response to the receipt of each of these responses, control point device 702 requests for the description documents describing the responding UPnP media renderer 706, op 816.

In response, the UPnP media renderers 706 provide the description documents as requested, op 818.

As alluded to earlier and to be more fully described below, on receipt of the identifications and description documents, control point device 102 advantageously makes visible these information through the user interface of control point device 702.

Examples of description information in a description document may include, but are not limited to, the renderer type, e.g. DVD player, media types supported, e.g. DVD, CD, VCD, the manufacturer, and so forth of a UPnP media renderer 706.

In various embodiments, operations 816 and 818 may be performed via one or more sets of requests and responses.

Thereafter, during operation, at an appropriate time, in response to a user selection to render a media content, control point device 702 instructs the applicable UPnP media renderers 706 accordingly, to receive/pull and render provided media contents 732 from UPnP media servers 704, op 820.

### Conclusion and Epilogue

Thus, it can be seen from the above descriptions, various novel data processing techniques have been described. While the present invention has been described in terms of the foregoing embodiments, those skilled in the art will recognize that the invention is not limited to the embodiments described. The present invention can be practiced with modification and alteration within the spirit and scope of the appended claims.

In particular, thread module chaining service 104 may further include the ability to facilitate passing of various parameter values to the methods of the chained modules during their chained execution to dynamically modify or tailor their execution behavior. Thread module chaining service 104 may be implemented as part of the extended or core operating system services.

Thus, the description is to be regarded as illustrative instead of restrictive on the present invention.

1. A method comprising:
a first module of a thread in a computing environment dynamically causing a second module to be logically chained to itself, enabling the second module to be executed as part of the same thread;
causing the second module dynamically and logically chained as part of the same thread to register first events of interest to the second module with an event notification service of the computing environment;
waiting for notification of occurrence of one or more of the first events; and
causing the second module dynamically and logically chained as part of the same thread to process an occurred one of the first events.

2. The method of claim 1, wherein
the second module comprises a first set of executable instructions designed to register the first events with said event notification service, and a first pointer to the first set of executable instructions;
the first module dynamically causing the second module to be logically chained to itself, by invoking a thread module chaining service of the computing environment; and
the method further comprises the thread module chaining service annotating a control data structure of the thread to logically associate the second module with the first module, including with the annotation, the first pointer to the first set of executable instructions of the second module.

3. The method of claim 2, wherein
said causing of the second module dynamically and logically chained as part of the same thread to register first events of interest to the second module with an event notification service of the computing environment comprises the first module invoking the thread module chaining service to orchestrate registration of events of interest to logically chained modules of the thread with the event notification service; and
the method further comprises the thread module chaining service retrieving the first pointer to the first set of executable instructions, and causing the first set of executable instructions to be executed, using the first pointer to locate the first set of executable instructions.

4. The method of claim 3, wherein
the second module further comprises a second set of executable instructions designed to process an occurred one of the first events, and a second pointer to the second set of executable instructions; and
the thread module chaining service further includes with the annotation, the second pointer to the second set of executable instructions of the second module.

5. The method of claim 4, wherein
said causing of the second module dynamically and logically chained as part of the same thread to process an occurred one of the first events comprises the first module invoking the thread module chaining service to orchestrate processing of an occurred event by the logically chained modules of the thread; and
the method further comprises the thread module chaining service retrieving the second pointer to the second set of executable instructions, and causing the second set of executable instructions to be executed, using the second pointer to locate the second set of executable instructions.

6. The method of claim 5, wherein the method further comprises
detecting for a thread termination condition; and
causing the thread to be terminated after detecting the thread termination condition.

7. The method of claim 6, wherein
the second module further comprises a third set of executable instructions designed to perform termination clean up for the second module, and a third pointer to the third set of executable instructions;
the thread module chaining service further includes with the annotation, the third pointer to the third set of executable instructions of the second module;
said detecting comprises the first module detecting for the thread termination condition;
said causing of the thread to be terminated after detecting the thread termination condition comprises the first module invoking the thread module chaining service to orchestrate thread termination clean up by the logically chained modules of the thread; and
the method further comprises the thread module chaining service retrieving the third pointer to the third set of executable instructions, and causing the third set of executable instructions to be executed, using the third pointer to locate the third set of executable instructions.

8. The method of claim 1, wherein the method further comprises
the first module dynamically causing a third module to be logically chained to the first and second modules, enabling the third module to be executed as part of the same thread;
causing the third module dynamically and logically chained as part of the same thread to register second events of interest to the third module with the event notification service of the computing environment; and
causing the dynamically and logically chained third module as part of the same thread to process an occurred one of the second events, said waiting for notification of occurrence further comprising waiting for notification of one or more of the second events.

9. A method comprising:
a first module of a thread in a computing environment dynamically causing a second module to be logically chained to itself, enabling the second module to be executed as part of the same thread;
waiting for notification of occurrence of one or more of first events of interest to the second module dynamically and logically chained as part of the same thread;
causing the second module dynamically and logically chained as part of the same thread to process an occurred one of the first events;
detecting for a thread termination condition; and
causing the thread to be terminated after detecting the thread termination condition.

10. The method of claim 9, wherein
the second module comprises a first set of executable instructions designed to process an occurred one of the first events, and a first pointer to the first set of executable instructions;
the method further comprises a thread module chaining service annotating a control data structure of the thread to logically associate the second module with the first module, including with the annotation, the first pointer to the first set of executable instructions of the second module;
said causing of the second module dynamically and logically chained as part of the same thread to process an occurred one of the first events comprises the first module invoking the thread module chaining service to orchestrate processing of an occurred event by logically chained modules of the thread; and
the method further comprises the thread module chaining service retrieving the first pointer to the first set of executable instructions, and causing the first set of executable instructions to be executed, using the first pointer to locate the first set of executable instructions.

11. The method of claim 10, wherein
the second module further comprises a second set of executable instructions designed to perform termination clean up for the second module, and a second pointer to the second set of executable instructions;
the thread module chaining service further includes with the annotation, the second pointer to the second set of executable instructions of the second module;
said detecting comprises the first module detecting for the thread termination condition;
said causing of the thread to be terminated after detecting the thread termination condition comprises the first module invoking the thread module chaining service to orchestrate thread termination clean up by the logically chained modules of the thread; and
the method further comprises the thread module chaining service retrieving the second pointer to the second set of executable instructions, and causing the second set of executable instructions to be executed, using the second pointer to locate the second set of executable instructions.

12. The method of claim 9, wherein
the second module comprises a first set of executable instructions designed to perform termination clean up for the second module, and a first pointer to the first set of executable instructions;
the method further comprises a thread module chaining service annotating a control data structure of the thread to logically associate the second module with the first module, including with the annotation, the first pointer to the first set of executable instructions of the second module;
said detecting comprises the first module detecting for the thread termination condition;
said causing of the thread to be terminated after detecting the thread termination condition comprises the first module invoking the thread module chaining service to orchestrate thread termination clean up by logically chained modules of the thread; and
the method further comprises the thread module chaining service retrieving the first pointer to the first set of executable instructions, and causing the first set of executable instructions to be executed, using the first pointer to locate the second set of executable instructions.

13. The method of claim 9, wherein the method further comprises
the first module dynamically causing a third module to be logically chained to the first and second modules, enabling the third module to be executed as part of the same thread; and
causing the third module dynamically and logically chained as part of the same thread to process an occurred one of second events, said waiting for notification of occurrence of one or more of first events further comprising waiting for notification of one or more of the second events.

14. A computing device comprising:
storage medium having stored therein a first plurality of executable instructions designed to provide a thread module chaining service to facilitate dynamic logical chaining of a plurality of modules to execute together as parts of a single thread on the computing device, including an ability to maintain and annotate a thread control data structure with control data to enable said logical chaining of the modules and their orchestrated execution as parts of a single thread; and
at least one processor coupled to the storage medium to execute the instructions.

15. The computing device of claim 14, wherein the ability to maintain and annotate a thread control data structure with control data to enable said logical chaining of the modules and their orchestrated execution as parts of a single thread includes an ability to annotate the thread control data structure with control data about a module to be logically chained to be a part of a thread, when dynamically invoked to logically chain the module to be a part of the thread.

16. The computing device of claim 15, wherein
the control data includes at least a selected one of
a pointer of the module pointing to a plurality of executable instructions of the module to register events of interest to the module with an event notification service of the computing device,
a pointer of the module pointing to a plurality of executable instructions of the module to process an occurred event of interest to the module,
a pointer of the module pointing to a plurality of executable instructions of the module to perform thread termination clean up for the module, and
the ability includes an ability to extract the selected one or more pointers from the module.

17. The computing device of claim 14, wherein the first plurality of executable instructions further provide the thread module chaining service with at least a selected one of
an ability to orchestrate registration of events of interest to the logically chained modules with an event notification service by the logically chained modules,
an ability to orchestrate processing of an occurred event of interest by one or more of the logically chained modules, and
an ability to orchestrate thread termination clean up of the logically chained modules by the respective logically chained modules.

18. The computing device of claim 14, wherein the computing device comprises a UPNP control point.

19. A computing device comprising:
storage medium having stored therein a first and a second module, with the first module equipped to logically chain the second module to the first module dynamically during execution of the first module, enabling the second module to execute with the first module as a single thread, and the second module having at least a selected one of a set of executable instructions to register events of interest to the second module, a set of executable instructions to process an occurred one of the events of interest, and a set of executable instructions to perform clean up during thread termination; and
at least one processor coupled to the storage medium to execute the instructions.

20. The computing device of claim 19, wherein the second module further includes at least a corresponding one of a first point, a second pointer, and a third pointer pointing to the first set, the second set, and the third set of executable instructions respectively.

21. The computing device of claim 19, wherein the computing device comprises a UPNP control point.

22. An article of manufacture comprising:
a computer readable medium; and
a plurality of executable instructions designed to implement a thread module chaining service to facilitate dynamic logical chaining of a plurality of modules to execute together as parts of a single thread in a computing environment, including an ability to maintain and annotate a thread control data structure with control data to enable said logical chaining of the modules and their orchestrated execution as parts of a single thread.

23. The article of claim 22, wherein the ability to maintain and annotate a thread control data structure with control data to enable said logical chaining of the modules and their orchestrated execution as parts of a single thread includes an ability to annotate the thread control data structure with control data about a module to be logically chained to be a part of a thread, when dynamically invoked to logically chain the module to be a part of the thread.

24. The article of claim 22, wherein the first plurality of executable instructions further provide the thread module chaining service with at least a selected one of
an ability to orchestrate registration of events of interest to the logically chained modules with an event notification service by the logically chained modules,
an ability to orchestrate processing of an occurred event of interest by one or more of the logically chained modules, and
an ability to orchestrate thread termination clean up of the logically chained modules by the respective logically chained modules.

25. A system comprising:
a first device including a plurality of executable instructions designed to implement a thread module chaining service to facilitate dynamic logical chaining of a plurality of modules to execute together as parts of a single thread in the first device, including an ability to maintain and annotate a thread control data structure with control data to enable said logical chaining of the modules and their orchestrated execution as parts of a single thread; and
a second device coupled to the first device.

26. The system of claim 25, wherein the ability of the thread module chaining service to maintain and annotate a thread control data structure with control data to enable said logical chaining of the modules and their orchestrated execution as parts of a single thread includes an ability to annotate the thread control data structure with control data about a module to be logically chained to be a part of a thread, when dynamically invoked to logically chain the module to be a part of the thread.

27. The system of claim 25, wherein the plurality of executable instructions further provide the thread module chaining service with at least a selected one of
an ability to orchestrate registration of events of interest to the logically chained modules with an event notification service by the logically chained modules,
an ability to orchestrate processing of an occurred event of interest by one or more of the logically chained modules, and
an ability to orchestrate thread termination clean up of the logically chained modules by the respective logically chained modules.

28. The system of claim 25, wherein the first computing device comprises a UPNP control point, and the second computing device comprises a selected one of a UPNP server and a UPNP renderer.

29. A system comprising:
a first device having a first and a second module, with the first module equipped to logically chain the second module to the first module dynamically during execution of the first module, enabling the second module to execute with the first module as a single thread, and the second module having at least a selected one of a set of executable instructions to register events of interest to the second module, a set of executable instructions to process an occurred one of the events of interest, and a set of executable instructions to perform clean up during thread termination; and
a second device coupled to the first device.

30. The system of claim 29, wherein the second module further includes at least a corresponding one of a first point, a second pointer, and a third pointer pointing to the first set, the second set, and the third set of executable instructions respectively.

31. The system of claim 29, wherein the first computing device comprises a UPNP control point, and the second computing device comprises a selected one of a UPNP server and a UPNP rendered.
